(19) United States
(12) Patent Application Publication
(10) Pub. No.: US 2015/0286690 A1
(43) Pub. Date: Oct. 8, 2015

(54) System and Method for Site and Tower Information Modeling and Management

(71) Applicant: Jiazhu Hu, Overland Park, KS (US)

(72) Inventor: Jiazhu Hu, Overland Park, KS (US)

(21) Appl. No.: 14/243,868

(22) Filed: Apr. 2, 2014

(51) Int. Cl. G06F 17/30

(52) U.S. Cl. CPC G06F 17/30554

(57) ABSTRACT

A system and method are herein disclosed for site and tower information modeling and management. The site and tower information contains data for the physical and functional characteristics of objects at a site and tower and engineering projects managing such data. Site and tower profile may be defined to identify data of a particular site and tower. Asset portfolio may be defined to manage a group of site and tower profiles. Engineering tasks may be defined to manage specific changes-related engineering work at a site and tower. Configurations may be defined to manage the settings, selections, and assumptions for design criteria and analysis option for engineering tasks. Configurations of information categories may be defined and combined to define site and tower information models. 2D and 3D visualizations may be generated to review and edit site and tower information models. Tenant projects may be created to manage engineering tasks.

### TECHNICAL FIELD OF THE INVENTION

The present invention relates generally to civil and structural engineering, engineering information management, telecommunications industry, and particularly, to a network-based system and method for site and tower information modeling and management.

### BACKGROUND OF THE INVENTION

Within less than forty years, wireless communication technology has evolved from 1G (1981) to 2G (1992), 3G (2002), and 4G (Current). With the swift technology renovation of wireless communication, plus the frequent system reconfiguration and maintenance between network generation upgrades, the telecommunications industry sees growing demands on engineering work for the development of wireless infrastructure, namely site and tower.

When building a new site or working on an existing site, stakeholders such as site and tower owner, co-location tenant, and engineering service provider each works on its own system with desired software and tools. These systems are disconnected and information needed for each system is transmitted through people-document-people interactions such as via emails and phone calls. Moreover, each system manages most site and tower information using paper-based or electronic documents and files. These documents and files are stored at storage facilities and local computers. More and more companies are using network-based services for document management. Compared to document management at local computers and storage facilities, network-based document management has all documents and files in electronic formats such as pdf, word, excel, txt, and dat. They are saved in online spaces and accessible to authorized users. It reduces costs and improves efficiency for document and file storing, accessing, and sharing. However, the fundamental process of performing engineering tasks does not change much. For every round of work, engineers still need to access to obtain, print out, read and interpret the paper-based or electronic documents for data, and then enter the data into computer applications to create new or update existing models and drawings. These models, for example, tower structural analysis model and foundation analysis model, typically form only parts of a site and tower. The data between these models are not interoperable.

The typical process of current engineering work for the development of site and tower is characterized by error-prone back and forth people-document-people communication. There are repetitive manual work of entering the same site and tower information for each system and between the rounds of work completed at one system. With the traditional process, there are widely observed redundancy among rounds of work for different projects, inconsistency in the interpretation of the same site and tower information by different engineer, and low-efficiency of project execution. The invention disclosed herein addresses these disadvantages by providing a system and method for site and tower information modeling and management. The system and method described herein provide a quality-improving, cost-saving, and value-creating solution by changing the way people access data, interact and collaborate with each other, and the process of executing engineering projects for site and tower development.

### BRIEF SUMMARY OF THE INVENTION

The following presents a simplified summary of one or more embodiments of the invention in order to provide a basic understanding of such embodiments. This summary is not an extensive overview of all contemplated embodiments, and is intended to neither identify key or critical elements of all embodiments nor delineate the scope of any or all embodiments. Its sole purpose is to present some concepts of one or more embodiments in a simplified form as a prelude to the more detailed description that is presented later.

The site and tower information modeling and management system described herein creates a database-supported site and tower information modeling and management system with thin-client web user interface through which user can manage site and tower information and perform engineering services for site and tower development. In accordance with several embodiments of the present invention, method and system for site and tower information modeling and management are described herein that include managing data in the system databases; managing user registration, user information, and user's privilege for accessing the system; managing site and tower owner asset portfolio, site and tower profiles for an asset portfolio; managing tenant project, linking site and tower profiles to tenant project, and monitoring tenant project progress; defining design criteria and analysis option configuration for loading calculation rules, structural modeling and analysis assumptions and settings; defining, visualizing, and editing site and tower information; and defining engineering task, executing the defined engineering task, and delivering results for the executed engineering task.

The following description with references to the accompanying drawings set forth in detail contain illustrative features and advantages as well as the structure and operation of the one or more embodiments of the present invention. These features are indicative, however, of but a few of the various ways in which the principles of various embodiments may be employed, and this description is intended to include all such embodiments and their equivalents.

### BRIEF DESCRIPTION OF THE DRAWINGS

FIG. 1 is a conceptual block diagram showing a network-based site and tower information modeling and management system, in accordance with one embodiment of the present invention

FIG. 2 is a conceptual block diagram showing the interaction between the users and the site and tower information modeling and management system through customized interfaces, in accordance with one embodiment of the present invention.

FIG. 3 is a conceptual block diagram showing various modules of the site and tower information modeling and management system, in accordance with one embodiment of the present invention.

FIG. 4 is a diagram showing the engineering task management module and the method of performing engineering task management, in accordance with one embodiment of the present invention.

FIG. 5 is a conceptual block diagram showing the site and tower information modeling module, in accordance with one embodiment of the present invention.

FIG. 6A shows exemplary tables for entering general information of structure configuration, in accordance with one embodiment of the present invention.

FIG. 6B shows exemplary tables for entering details of structure configuration, in accordance with one embodiment of the present invention.

FIG. 7 shows an exemplary table for entering general information of loading configuration, in accordance with one embodiment of the present invention.

FIG. 8 shows a partial view of an exemplary 3D visualization of a site and tower information model, in accordance with one embodiment of the present invention.

FIG. 9 illustrates an exemplary 3D visualization of a platform-type tower mounting structure, in accordance with one embodiment of the present invention.

FIG. 10 is a logic block diagram for 2D and/or 3D visualization of objects, in accordance with one embodiment of the present invention.

FIG. 11 is a logic block diagram showing the attaching relationships between objects in configurations of a site and tower information model for 2D and/or 3D visualization generation, in accordance with one embodiment of the present invention.

FIG. 12A lists the primary translational offsets Offset_A2B and rotational angles Gamma_A2B between the local coordinate systems used in the network-based system.

FIG. 12B shows the relationships between the local coordinate systems used in the network-based system.

FIG. 12C illustrates an exemplary 2D visualization showing various local offsets and rotation gamma angles between local coordinate systems of objects defined in configurations for a site and tower information model, in accordance with one embodiment of the present invention.

FIG. 13 illustrates an exemplary reviewing and editing panel for details of structure configuration at a 2D and/or 3D visualization interface, in accordance with one embodiment of the present invention.

FIG. 14 is a conceptual block diagram showing a method of site and tower information modeling and management, in accordance with one embodiment of the present invention.

### DETAILED DESCRIPTION OF THE INVENTION

In the description that follows, numerous details are set forth in order to provide a thorough understanding of the invention. It will be appreciated by those skilled in the art that variations of these specific details are possible while still achieving the results of the invention. Well-known elements and processing steps are generally not described in detail in order to avoid unnecessarily obscuring the description of the invention. While the invention described herein is described in connection with various preferred embodiments, it is understood that the invention is not limited to those particular embodiments. Rather, the description of the invention is intended to cover various alternatives, modifications, and equivalent arrangements. Particular features, structures, characteristics, and elements of one or more embodiments may be combined in suitable manners in one or more embodiments.

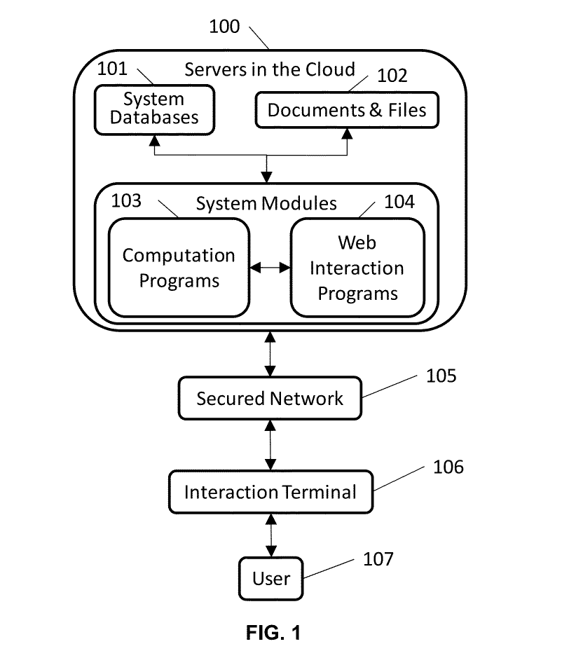

FIG. 1 is a conceptual block diagram showing the network-based site and tower information modeling and management system (called the network-based system thereafter) 100. The network-based system 100 comprises system databases 101, documents and files 102, computation programs 103, and web interaction programs 104. System databases 101 and documents and files 102 contain various data for actions to be performed by computation programs 103 and web interaction programs 104. Computation programs 103 and web interaction programs 104 make up various functional system modules of the network-based system 100. The network-based system 100 may be accessed by an user 107 through secured network 105 from internet browsers, mobile applications, and customized interaction programs installed at network-connected interaction terminal 106. Interaction terminals 106 comprise computers, tablets and mobile devices. The system databases 101 and documents and files 102 may be all digital and saved at servers in the cloud accessible through secured network 105 such as internet.

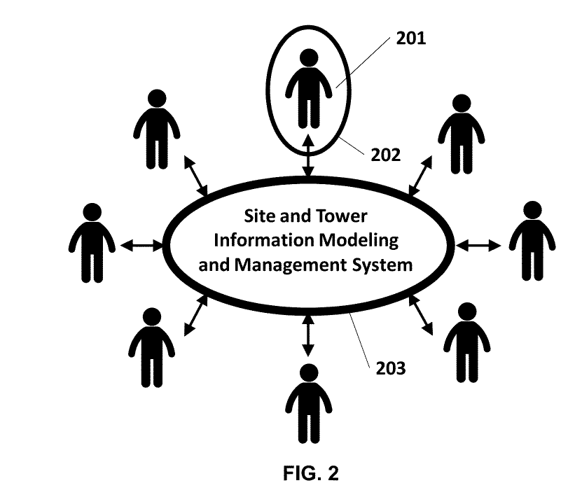

FIG. 2 is a conceptual block diagram showing interactions between users 201 and the network-based system 100 through customized interface 203. The user 201 may be any personnel and organization involved in the process of telecommunications infrastructure development. Primary users include system administrator, site and tower owner (STO), wireless carrier, site and tower manufacturer (STM), engineering service provider (ESP). As one embodiment of the invention, the accounts of all users 201 of the network-based system 100 are managed by a system user account management module 202. A module is a set of computer programs developed to perform serial computer actions for specific purpose. Through the system user account management module 202, the network-based system 100 may be accessed by varied type of users with assigned access privileges. User 201 may register a new user account at a customized interface 203 where user 201 can enter new user account information. User account information is specific information related to a particular personnel or organization. User account information comprises first name, last name, date of birth, e-mail address, company name, company address, phone number, account type, and job title. The system user account management module 202 may verify and activate user account after user 201 submitted the new user account information. User account information of a particular user 201 may be edited by the user 201 or a system administrator. System administrator may assign a registered user access privileges to access parts or all of the network-based system 100 according to the user account information. The access privileges differentiate account types on accessing specified parts of the network-based system 100. As one embodiment of the invention, each type of user may be directed to an interface designated for the type of user upon login. From the interface designated for a type of user, the user 201 may only access to specified parts of the network-based system 100 the user 201 has access privileges. Specified parts may be one or multiple parts of one or multiple modules of the network-based system 100.

As another embodiment of the invention, the interactions between the user 201 and the network-based system 100 are done through customized interface 203. The customized interface 203 is interaction interface designed with style, layout, interaction elements, and methods customized according to the type of user's industry standard and practice. With customized interface 203, user 201 may have the best experience of easiness and friendliness for using the network-based system 100. Through the network-based system 100 with customized interface 203, system administrator may create and manage system supporting data; site and tower owner may create and manage site and tower profile and build up site and tower owner asset portfolio; co-location tenant may create and manage co-location tenant project for its network upgrade and maintenance; engineering service provider, upon the request and with authorization from site and tower owner or co-location tenant, may perform various engineering work. All above said tasks are created and executed through various modules of the network-based system 100.

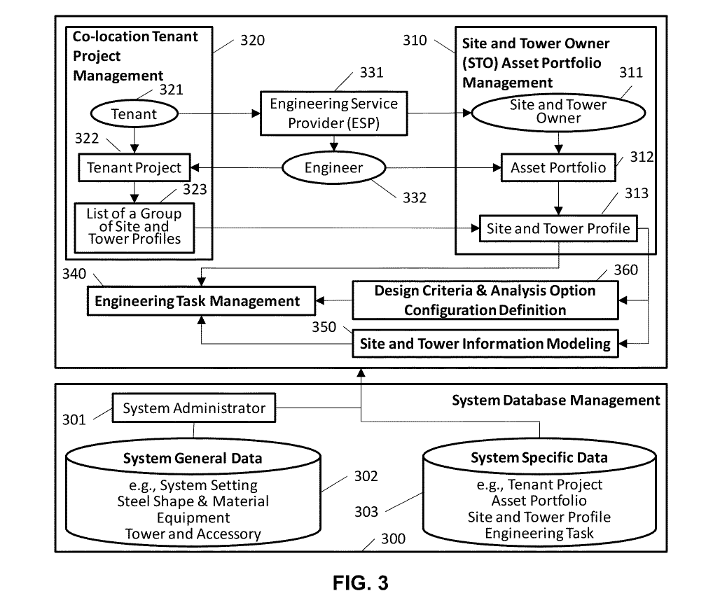

FIG. 3 is a conceptual block diagram showing various modules of the site and tower information modeling and management system 100. The networked-based system 100 comprises system database management module 300, system user management module 202, site and tower owner asset portfolio management module 310, co-location tenant project management module 320, engineering task management module 340, site and tower information modeling module 350, and design criteria and analysis option configuration definition module 360.

Within the site and tower owner asset portfolio management module 310, site and tower owner 311 manages its asset portfolio 312 representing a group of site and tower profiles 313. A site and tower profile 313 is defined by site and tower profile information—a set of data defining an unique site and tower. Site and tower profile information comprises site ID, site name, Federal Communications Commission (FCC) registration information, Federal Aviation Administration (FAA) registration information, address, latitude and longitude, site type, structural type, structural height, ownership information, leasing information. Ownership information comprises owner name, owner's name and ID for a site and tower, ownership starting and ending date. Leasing information comprises tenant name, tenant's name and ID for the site and tower, the starting and ending date of tenant's lease. The site and tower profile webpage may have embedded geographic information service application to provide geographic information of a site and tower. The geographic information service application comprises Google map, Bing map, Google earth. In one embodiment, within the site and tower owner asset portfolio management module 310, site and tower owner 311 and its representative may enter new asset portfolio information to define a new asset portfolio 312, edit existing asset portfolio information, and manage site and tower profiles 313 of an asset portfolio by adding site and tower profiles to and removing site and tower profiles from the asset portfolio. In another embodiment, the asset portfolio management module 310 comprises programs to generate plots, charts, and other Rich Internet Application (RIA) elements to present and edit asset portfolio information and site and tower information. Asset portfolio information comprises asset portfolio general information and asset portfolio statistical information. Asset portfolio general information comprises asset portfolio name, number of site and tower profiles under the asset portfolio. Asset portfolio statistical information comprising statistical information of a group of site and tower profiles under an asset portfolio according to site and tower profile information of each site and tower profile in the asset portfolio.

Within the co-location tenant project management module 320, co-location tenant 321 manages the tenant project 322 which manages the projects of a group of site and tower profiles 323. In one embodiment, co-location tenant 321 and its representative may create new and edit existing co-location tenant project 322. Within the co-location tenant project management module 320, co-location tenant 321 and its representative may search for site and tower profiles 313 in one or multiple site and tower owner asset portfolios 312 using searching criteria. The searching criteria comprises site and tower geographic information, structural capacity, number of tenant, tenant's name, site and tower profile information. From the returned searching result, co-location tenant 321 and its representative may select site and tower profiles 313 and link them to a co-location tenant project 322. Plots, charts, and other Rich Internet Application (RIA) elements may be used to present and edit tenant project information. Tenant project information comprises tenant project general information and tenant project statistical information. Tenant project general information comprises tenant name, creation date, market region, description, number of site and tower profiles, project progress. Tenant project statistical information comprises statistical information of a group of site and tower profiles of a tenant project according to tenant project general information and the site and tower profile information. Within the co-location tenant project management module 320, co-location tenant 321 and its representative may select a tenant project 322, search site and tower profile list 323 of the project, and then select a site and tower profile 313 to enter the homepage of a site and tower profile 313. Within the site and tower owner asset portfolio management module 310, site and tower owner 311 and its representative may select a site and tower profile 313 by searching the site and tower profile list of an asset portfolio 312 to enter the homepage of a site and tower profile 313. Further, users, either co-location tenants 321, site and tower owners 311 or their representatives, may enter the engineering task management module 340 from the site and tower profile 313. Engineering task management module 340 defines new and edits existing engineering tasks. A defined engineering task comprises one design criteria and analysis opinion configuration and one site and tower information model. Site and tower information modeling module 350 defines site and tower information model. Design criteria and analysis opinion configuration definition module 360 defines design criteria and analysis opinion configuration.

Users may add new and edit existing engineering task in the engineering task management module 340. Engineering task is typically linked to specific co-location tenant project 322 and a site and tower profile 313. An engineering task may be listed for display for co-location tenant 321 and its representatives having the access privilege to the co-location tenant project 322 only. As one embodiment, site and tower owner 311, owns the site and tower, always have full access to all engineering tasks for a site and tower profile. As another embodiment, the engineering task management module 340 further execute engineering task, and deliver results for the executed engineering task.

The database management module 300 provides supports to all system modules by managing system databases 101. User may add new data to and edit existing data of the system databases 101. As one embodiment, the system databases 101 may be installed at the server managed by the network-based system 100, the co-location tenant 321, and site tower owner 311 and their representatives. There are two types of data in the system databases 101, system general data 302 and system specific data 303. System general data 302 is data for general information of the network-based system 100. System specific data 303 is data related to specific tenant 321, tenant project 322, site and tower owner asset portfolio 312, site and tower profile 313, and engineering task. The system general data 302 comprises data for wireless communication equipment, structural steel shape, structural connection, material, masonry structural product, wood structural product, soil, design code, tower structural type, lattice tower bracing type, modular tower section, and foundation type. The wireless communication equipment comprises flat panel antenna, dish antenna, and remote radio head (RRH), etc. The database management module 300 facilitates adding new data and editing existing data in the system databases 101. As one embodiment of the invention, system administrator 301 has the privilege to directly add new and edit existing system general data 301 in the system databases 101. Other uses may propose addition and modification to system general data 302. The proposed addition and modification may be applied to the system databases 101 upon approval from system administrator 301.

As another embodiment, users may extract, transform, and load (ETL) data from external data source or manually entering data to the system databases 101. External data sources for system general data 302 may share remote data with the network-based system 100 by providing the network-based system 100 access to the remote data. Exemplary external data sources include but not limited to site and tower manufacturer's product databases, equipment manufacturer's product databases, and other industry databases. System specific data 303 is created and managed directly by the tenant 321, site and tower owner 311 and their representatives during the process of managing asset portfolio 312, site and tower profile 313, tenant project 322, and engineering task. As an embodiment, system specific data 303 may be saved at storage managed by co-location tenant 321 and site and tower owner 311 and to be accessed by and loaded to the network-based system 100 with authorization of the co-location tenant 321 and site and tower owner 311.

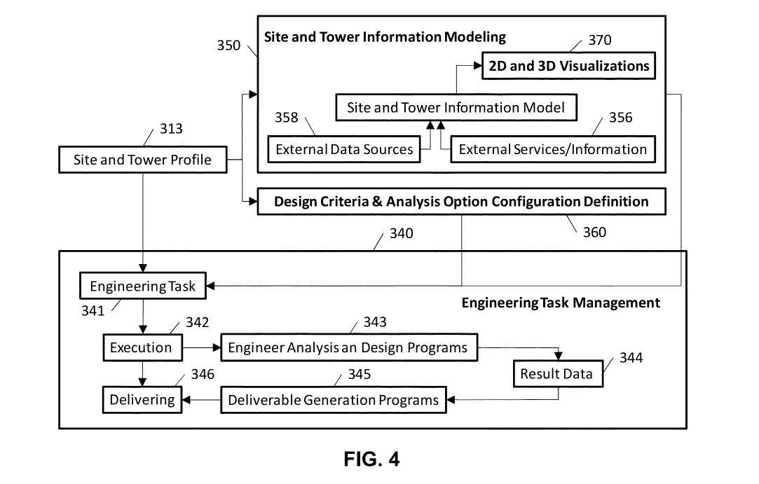

FIG. 4 is a diagram showing the engineering task management module 340 and the method of performing engineering task management. Engineering task is serial engineering analysis and design work. Exemplary engineering task includes but not limited to loading analysis, structural analysis, foundation analysis, structural modification design and analysis, and construction support. As an embodiment, the step of managing engineering task comprises defining engineering task 341, executing engineering task 342 by running engineering analysis and design programs 343, generating result data 344, and then delivering the executed engineering task 346 by running deliverable generation programs 345.

A defined engineering task 341 comprises one design criteria and analysis opinion configuration and one site and tower information model. Site and tower information modeling module 350 defines site and tower information model. Design criteria and analysis opinion configuration definition module 360 defines design criteria and analysis opinion configuration. A design criteria and analysis option configuration is a set of data defining rules for loading calculation, making assumptions and defining settings for engineering modeling and engineering analysis. The engineering modeling comprises wind load modeling, structural modeling, soil modeling. Exemplary engineering analysis comprises loading analysis, structural analysis, and foundation analysis. Design criteria includes but not limited to criteria such as ASCE 7—Minimum Design Loads for Buildings and Other Structures, ANSI/EIA/TIA-222—Structural Steel Standards for Steel Antenna Towers and Supporting Structures standard, and ANSI/AISC 360—Specification for Structural Steel Buildings. Analysis option includes but not limited to structural modeling assumptions, structural analysis parameters. The site and tower information model for a site and tower is a digital representation of both the physical and functional characteristics of objects at the site and tower. Site and tower information model comprises configurations of information categories. The data for each configuration of information category may obtained through external services and information sources 356. As another embodiment, the data for configuration of information category may be imported from external data sources 358. External data sources 358 comprise data files generated by other softwares and tools such as tnxTower and Lpile. Defined site and tower information model may be reviewed and edited through 2D and/or 3D visualizations 370 generated for objects defined in the site and tower information model. As one embodiment, users may define multiple design criteria and analysis option configurations and multiple site and tower information models. Only one design criteria and analysis option configuration and one site and tower information model are needed for defining an engineering task 341.

The defined engineering task 341 for a site and tower profile 313 may be executed and delivered. Upon execution request, the engineering task management module 340 will generate input files, create analysis model, calculate loads and apply loads to the analysis model, perform analysis, and perform analysis result checking. The analysis model includes but not limited to finite-element model and finite-difference model. Loads include but not limited to wind load, snow and ice load, self-weight, and seismic load. Analysis result data 344 may be saved to system databases 101. The data may be further extracted by the deliverable generation programs 345 to generate deliverables. Exemplary deliverables include but not limited to structural analysis reports, foundation analysis calculations, tower modification design, and construction drawings. The analysis result checking includes but not limited to design code compliance check and jurisdiction requirement check. Checked and verified deliverables may be then submitted and presented to clients and customers.

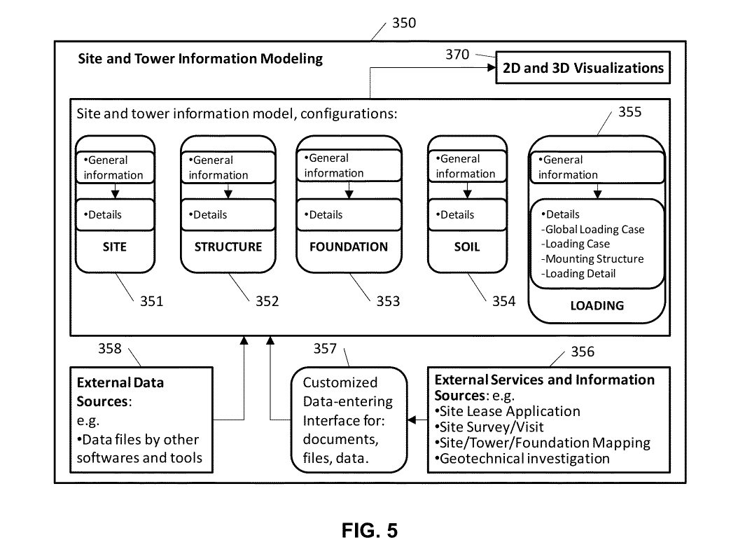

FIG. 5 is a conceptual block diagram showing the site and tower information modeling module 350. A defined site and tower information model has multiple configurations for different information categories. The information categories include but not limited to site, soil, structure, foundation, and loading. The corresponding configurations of information categories are site configuration 351, structure configuration 352, foundation configuration 353, soil configuration 354, and loading configuration 355. Site configuration 351 defines information for site layout, all equipments on the ground and underground, equipment connections, and other facilities at the site. Structure configuration 352 defines information of all structural coordinate, position, geometry, dimension, connectivity, and material. Foundation configuration 353 defines information of foundation geometry, dimension, position, material, and reinforcement. Soil configuration 354 defines the soil properties of one or multiple soil layers at one or multiple boring locations at a site. The soil properties further define the geotechnical parameters for geotechnical design and analysis. Loading configuration 355 defines physical and functional information of all loading objects on the structure at a site and tower. The loading objects include but not limited to linear and discrete appurtenances such as antennas, flash lights, climb ladders, and feedlines.

For each configuration type, its data is organized as two mutually referred parts, general information and details. Defining a new configuration means entering new general information and details for the new configuration. Editing existing configuration means editing existing general information and details for the existing configuration. Defining a new configuration may be done through copying an existing configuration, renaming its name, and editing its general information and details. General information is mostly identification and bookkeeping information for a configuration. It typically includes information such as record date, service vendors, base configuration identification, modification configuration identification, and notes. The details of a configuration are technical information for corresponding information category. For example, the details of site configuration 351 comprise information of the physical and functional characteristics of all objects on the site. The details of structure configuration 352 comprise the coordinates of nodes, connectivity of members, dimensions, and material of members. The details of foundation configuration 353 comprise the foundation size and shape, foundation location and orientation. The details of soil profile configuration 354 comprise the soil types and geotechnical parameters of each type of soil at the site. The details of loading configuration 355 comprise the loading acting position, magnitude, directions, and static and dynamic characteristics. There are identifiers for both general information and details for configurations. Primary identifiers are Site ID, tower ID, engineering task ID, and configuration ID. Additional identifiers may be used for the general information and details for each configuration.

As an embodiment, the general information and details of a configuration may be entered to the network-based system 100 and edited by co-location tenant 321, site and tower owner 311 and their representative such as engineers 332 of engineering service providers 331. The network-based system 100 may have customized data-entering interface 357 for each type of configuration. The general information and details of a configuration may be entered to the network-based system 100 through external services and information sources 356. Through the external services and information sources 356, services may be ordered from service providers for the configurations by sending emails and messages. Contractors may be hired to perform the services. Main external services comprise new site and tower design, site survey, site audit, site mapping, tower mapping, geotechnical investigation, foundation mapping, and construction support. As an embodiment, a service request like a purchase order may be created in the network-based system 100 and sent to a selected contractor. Upon receiving the service request from the network-based system 100, the contractor has the information needed to conduct the service. The request may include an encrypted link which has a valid period within which the contractor may access the linked web page to upload documents and files, and enter data for the ordered services to the network-based system 100. The network-based system 100 may need to create links between the uploaded documents and files and the entered data for corresponding configurations in the system databases 101. Further, the external information services and information sources 356 may have customized data-entering interface 357 for each type of services. Customized data-entering interface 357 for the general information and details of a configuration may include tables, forms, and other Rich Internet Application (RIA) elements. The service documents and files comprise leasing documents, agreements and contracts, co-location applications, site survey and audit reports, site photos, site layout drawings, structural analysis reports, structural drawings, mapping reports, geotechnical investigation reports, foundation design calculation, foundation drawings, foundation mapping report, loading information, and construction drawings. As another embodiment, the general information and details of configurations may be imported and loaded from external data sources 358. External data sources 358 are external site and tower information data files generated by softwares and tools other than the network-based system 100. Exemplary site and tower information data files are data files generated by tnxTower and Lpile. The network-based system 100 may provide interfaces for other disciplinary engineers. As an example, the network-based system 100 may provide a web interface for RF engineer to enter the RF design data for a site. The information includes complete information of a RF and network design at a site, which is typically outlined in primary site development files such as site lease application.

As one embodiment, the definition of general information and details of loading configuration 355 takes a few more steps. A list of mounting structures may be added on a structure such as tower for a new or existing loading configuration. Mounting structures on existing loading configuration may be edited. New independent loading cases may be defined for each new and existing mounting structure on the structure. Existing independent loading case may be edited for existing mounting structure. The loading details may be then defined or edited for each independent loading case. In addition, new independent loading case (LC) may be defined by copying existing independent loading case (LC), renaming it, and editing its loading details. To create a global loading case (GLC) for the site and tower information model, one or none independent loading case (LC) for each mounting structure in the list needs to be selected. Existing global loading case (GLC) may be edited by modifying its independent loading cases (LC) and associated loading details. New global loading case (GLC) may be defined by copying existing global loading case (GLC), renaming it, and editing its independent loading case (LC) and associated loading details. The loading details for mounting structure includes but not limited to:
attaching relationships between objects of the site and tower information model;
information of global coordinate system and local coordinate systems of objects of the site and tower information model, relative translational offsets and rotational angles between the global coordinate system and the local coordinate systems, and relative translational offsets and rotational angles between the local coordinate systems;
identification information and position information of the mounting structure, discrete appurtenances attached to the mounting structure, and linear appurtenances connecting to the discrete appurtenances;
information of attaching members on the mounting structure for the discrete appurtenances; and
information of attaching members on structure for the linear appurtenances.

As an embodiment, the site and tower information modeling module 350 would be able to define multiple independent loading cases (LC) for each mounting structure and combine certain mounting structure and associated independent loading cases (LC) to define multiple global loading cases (GLC) and loading configurations. Moreover, multiple configurations may be defined for each information categories including site, structure, foundation, soil, etc. By selecting one or none configuration for each information category, the site and tower information modeling module 350 would be able to define multiple site and tower information models. Since the independent loading case (LC) is not dependent on the site and tower information, it can be easily copied to other global loading case (GLC) of same or even another site and tower profile. These features tremendously help manage the co-location tenant's wireless network upgrade and maintenance projects by facilitating swift loading test and change out implementation for multiple sites.

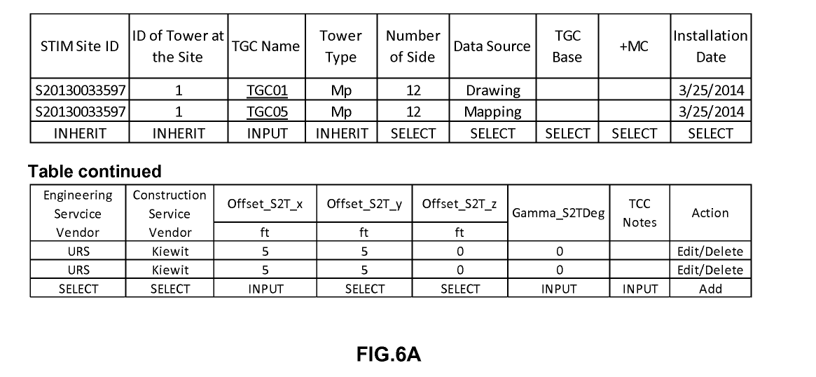

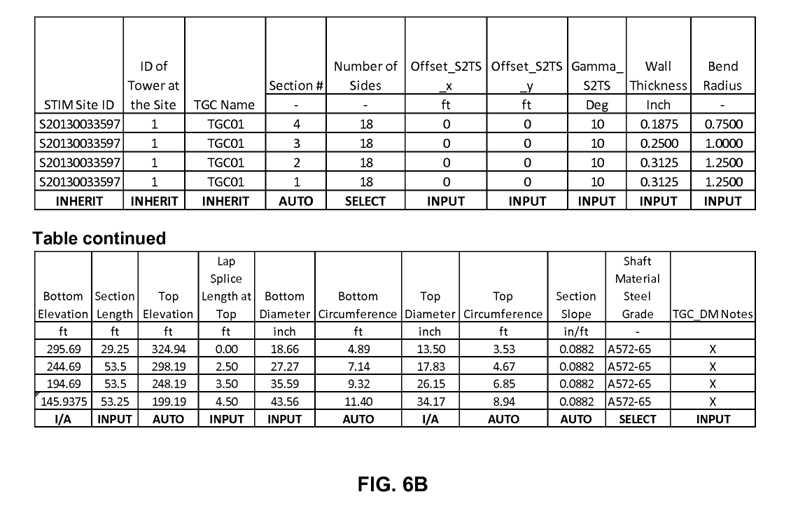

FIG. 6A and FIG. 6B show exemplary tables for entering general information and details of structure configuration, respectively. The structure is a monopole tower in this case. FIG. 6A shows the table for the general information. In this table, there are system site ID—STIM Site ID, Tower ID at the site, Tower Geometry Configuration Name—TGC Name, and other general information for a structure configuration. The hyperlink of TGC Name links to the details of a structure configuration shown in FIG. 6B. FIG. 6B shows a table listing the details of a structure (tower geometry) configuration. In the table FIG. 6B, all details needed for the definition of a monopole tower are specified.

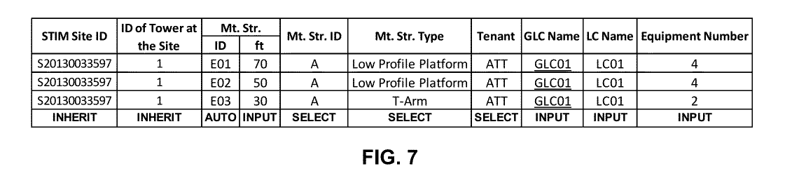

FIG. 7 shows an exemplary table for entering general information of loading configuration, in accordance with one embodiment of the present invention. In this table, there are system site ID—STIM Site ID, ID of Tower at the site, Global Loading Configuration Name—GLC Name, Independent Loading Case name—LC Name, and other general information for a loading configuration. The hyperlink of GLC Name links to the details of a loading configuration. As an embodiment, for each global loading configuration (GLC), there may have multiple mounting structure and for each mounting structure, its loading case is designated with an independent loading case name (LC). For each mounting structures, there may have multiple mounting pipes. For each mounting pipe, there may have multiple equipments. Equipments may be directly attached to mounting structure. The mounting pipe can be attached to the structure directly without through mounting structure. The specifications of equipment, mounting pipe, mounting structure, structure (tower), and their attaching relationships are to be defined for each LC and GLC in the details of a loading configuration.

A defined site and tower information model may be visualized with 2D and/or 3D graphical representation of some objects using the physical object's geometrical and material information defined in the site and tower information model. A physical object's geometrical and material information is either directly defined or can be retrieved from the system databases 101 according to the general information and details of the configuration defining the physical object. The site and tower information modeling module 350 has a 2D and/or 3D visualization engine. The 2D and/or 3D visualization engine is a set of programs to generate 2D and/or 3D graphical representation of objects. Using the general information and details for all configurations for a site and tower information model, the 2D and/or 3D visualization engine of the network-based system 100 would generate 2D and/or 3D visualizations 370 of each physical object defined in a site and tower information model and assemble them according to the attaching sequence to create a 2D and/or 3D visualizations 370 for the whole site and tower information model. The network-based system 100 may calculate and determine the position, orientation, and dimension of each object defined in the site and tower information model. Materials and other scenic information may be applied for visual effect.

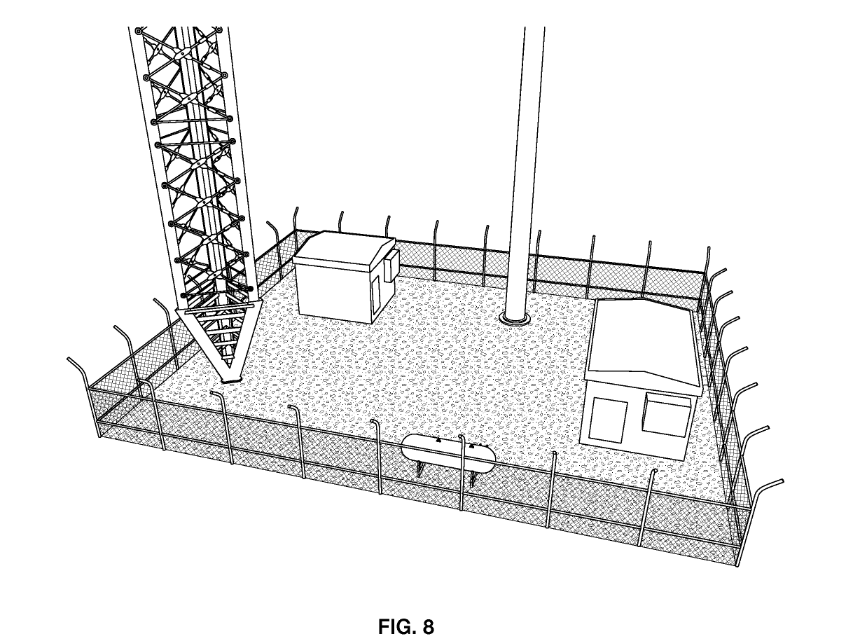

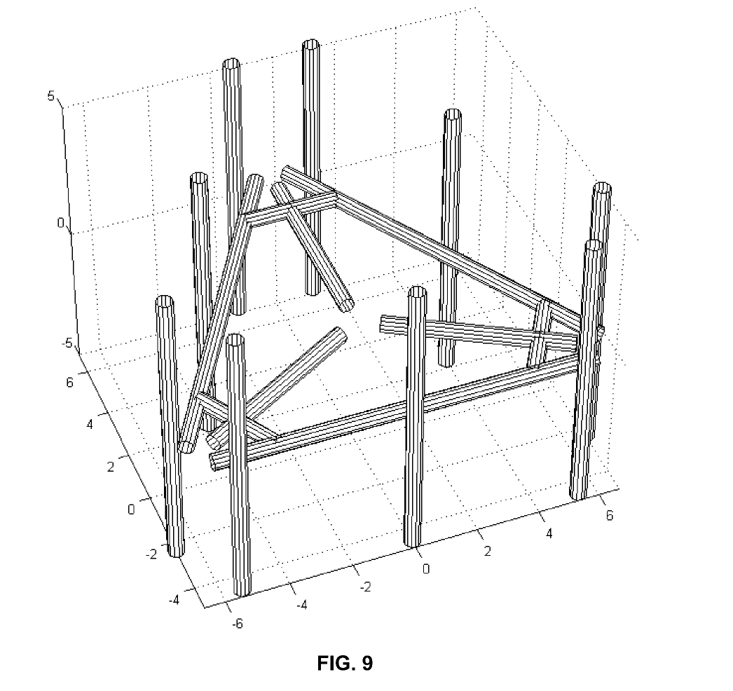

FIG. 8 shows a partial view of an exemplary 3D visualization of a site and tower information model generated by the 2D and/or 3D visualization engine of the network-based system 100. As an embodiment, in 2D and/or 3D visualizations 370, the status of equipments, active, inactive, proposed, or reserved for future may be indicated using distinctive legends. The equipments with the same status, belonging to the same carrier, sharing model name, and sharing tower sections may be displayed as a group upon selection of 2D and/or 3D visualization settings. Moreover, a 2D and/or 3D visualization engine may generate 2D and/or 3D visualizations 370 of specified components and parts of a site and tower information model only. Further, the 2D and/or 3D visualization engine may generate 2D and/or 3D visualizations 370 of equipments and structures independent of a site and tower information model of any engineering task, site and tower profile, and tenant project. For example, referring to the type, model, and manufacturer information of an object, the network-based system 100 would retrieve the geometry and material data from the system databases 101 and create 2D and/or 3D visualizations 370 of the object in its local coordinate system. FIG. 9 illustrates an exemplary 3D visualization of a platform-type tower mounting structure.

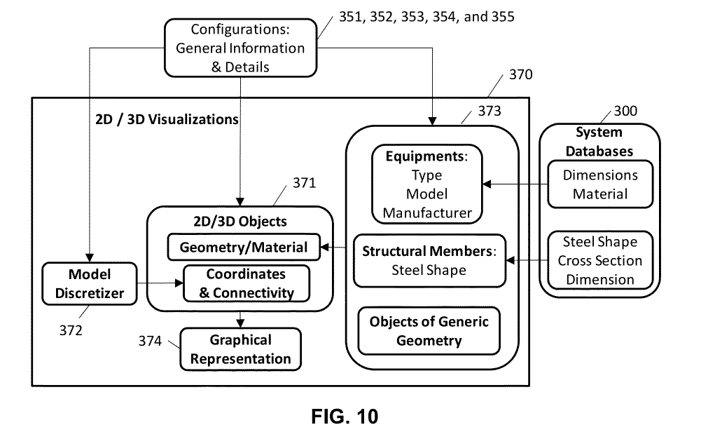

FIG. 10 shows a process of how the necessary data is retrieved from the network-based system 100 for the generation of 2D and/or 3D visualizations 370 of objects defined in a site and tower information model. To generate 2D and/or 3D visualizations 370 of an object defined in a site and tower information model, the 2D and/or 3D visualization engine needs three types of information - geometry, position, and material 371. The geometry is about the dimensions of the object. The position is about the location of the object in the coordinate system. Material is about the texture of the object's surfaces and body. As an embodiment of the invention, the 2D and/or 3D visualization engine of the network-based system 100 has a Model Discretizer 372 which determines the position of an object in a coordinate system, for example, the coordinates of the vertices of an object and associated connectivity. The geometry and dimensions of an object may be either given explicitly in the details of configurations or obtained by referring to the system databases 101 using the given type, model, manufacturer, and other identification information of an equipment or steel shape of a structural member 373. Some objects are of generic geometry directly available from the 2D and/or 3D visualization engine of the network-based system 100.

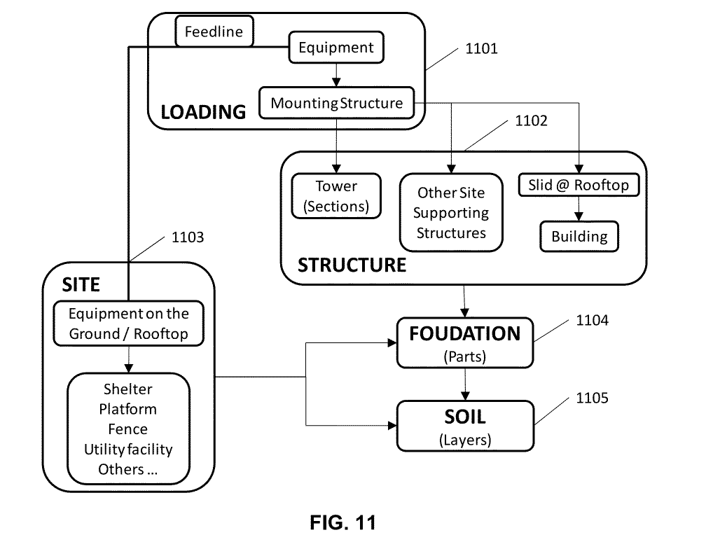

The 2D and/or 3D visualizations 370 of individual object in a site and tower information model, once created, need to be assembled to create the 2D and/or 3D visualizations 370 of the whole site and tower information model. As an embodiment, the assembling process follows the physical attaching sequence of objects in reality. FIG. 11 is a logic block diagram showing the attaching relationships between objects in configurations of a site and tower information model for the generation of 2D and/or 3D visualizations 370. The loadings 1101, including equipments supported by the structure 1102 are connected to the ground equipments sit on the site 1103 through feedlines. There are varied types of structures 1102, including towers, general buildings, and other supporting structures such as water tank, bell/clock tower, and church buildings. The supporting structures and site facilities sit on foundation 1104 and then the ground earth of soil 1105, or directly on the ground earth of soil 1105 without foundation. The attaching sequence defines a parent-child logic relationship in which the supporting object is like parent and the supported object is like child of the parent. As an embodiment, all objects in the site and tower information model has local coordinate system. The physical and functional characteristics are typically defined in the each object's own local coordinate system. The process of generating 2D and/or 3D visualizations 370 of objects in a site and tower information model in a global coordinate system is one process of performing coordinate transformation for the 2D and/or 3D visualizations 370 of objects generated in their local coordinate systems. The process may be done either by the network-based system 100 through serial coordinate transformation calculations or by the 2D and/or 3D visualization engine's internal process which requires explicit definition of attaching relationships between objects.

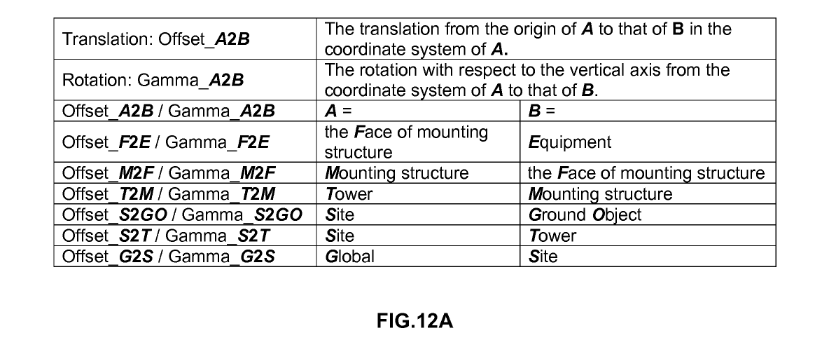

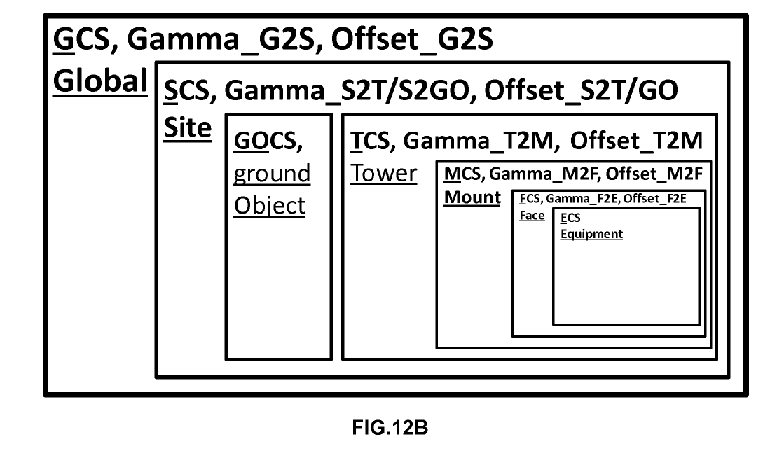

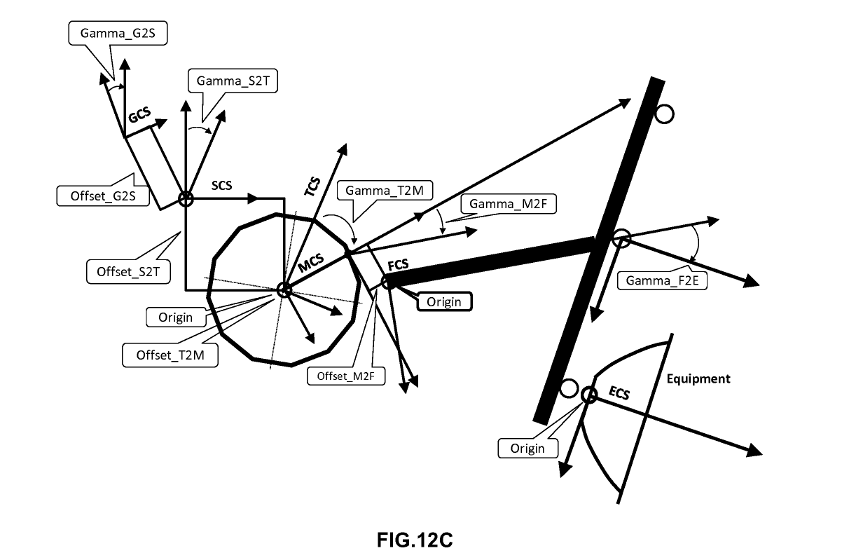

The sequential attaching of objects defined in configurations of a site and tower information model for a 2D and/or 3D visualizations generation are implemented by the system modules which, to get global coordinates, perform coordinate transformations implementing specified translations and rotations in object's local coordinate systems. According to the child-parent relationship of objects, translations are the offsets of a physical object's local coordinate system from its parent object's local coordinate system. Rotations are sequential Euler angles of axes from the local coordinate system of parent object to that of a child object. The primary rotation angles defined for objects at a site and tower information model are those with respect to vertical axles (upward pointing to the sky) and they are named as Gamma_A2B where A refers to the parent and B the child. FIG. 12A lists the primary translational offsets Offset_A2B and rotational angles Gamma_A2B between the local coordinate systems used in the network-based system 100. For designation convenience, one letter is chose to represent the local coordinate system of objects in the site and tower information model. These values are defined in the general information and details of configurations for a site and tower information model. FIG. 12B shows the relationships between the local coordinate systems used in the network-based system 100. The frame and corresponding translational offsets and rotational angles of local coordinate system of a child object is located inside the frame of the local coordinate system of a parent object. FIG. 12C illustrates an exemplary 2D visualization showing various local offsets and rotation gamma angles between local coordinate systems of objects defined in configurations for a site and tower information model. In the example, configurations includes site, structure (tower) and loading. The loading is further divided as mounting structure, mounting structure face and equipment, each having a local coordinate system. The defined translational offsets and rotational angles are described below.
Defined in the global coordinate system (GLC), the offset of the origin of site coordinate system (SCS) from GLC's origin is given by Offset_G2S and the rotation from GLC to SCS is Gamma_G2S.
Defined in the local coordinate system of site (SCS), the offset of the origin of the local coordinate system of tower (TCS) from SCS's origin is given by Offset_S2T and the rotation from SCS to TCS is Gamma_S2T.
Defined in the local coordinate system of tower (TCS), the offset of the origin of the local coordinate system of mount (MCS) from TCS's origin is given by Offset_T2M and the rotation from TCS to MCS is Gamma_T2M.
Defined in the local coordinate system of Mount (MCS), the offset of the origin of the local coordinate system of mount's face (FCS) from MCS's origin is given by Offset_M2F and the rotation from MCS to FCS is Gamma_M2F.
Defined in the local coordinate system of Mount face (FCS), the offset of the origin of the local coordinate system of equipment (ECS) from FCS's origin is given by Offset_F2E and the rotation from FCS to ECS is Gamma_F2E.

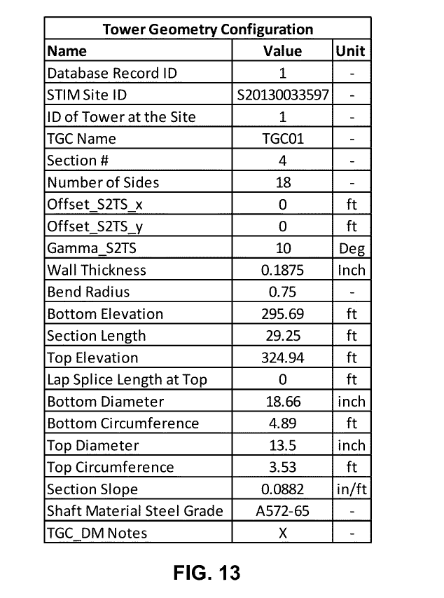

The 2D and/or 3D visualization engine facilitates reviewing and editing of the general information and details of configurations for a site and tower information model. User may click on any object in the 2D and/or 3D visualizations 370 and a reviewing and editing dialogue window may pop up. The dialogue window may show tables and forms listing the general information and details of the selected object. User may change the general information and details in the dialogue and update the system databases 101. The 2D and/or 3D visualization engine will then re-generate the 2D and/or 3D visualizations 370 of the updated site and tower model. FIG. 13 illustrates an exemplary reviewing and editing panel for details of structure (tower) configuration at a 2D or 3D visualization interface. The selected object is the tower section with Section # being 4 in FIG. 6B.

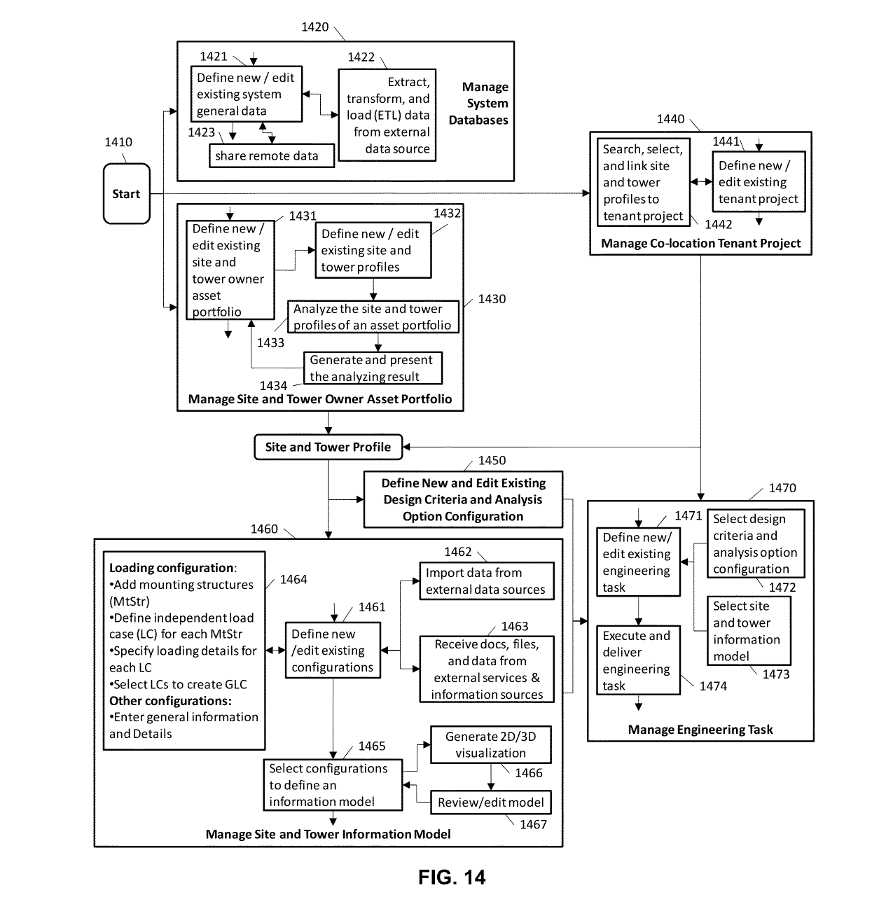

FIG. 14 is a conceptual block diagram showing a method of site and tower information modeling and management. At the start 1410, user will be logged into specified parts of the network-based system 100 according to the access privileges assigned to the user. The specified parts of the network-based system 100 may be one or multiple parts of one or multiple modules of the network-based system 100. At step 1420, system database management module 300 defines new and edits existing system general data at step 1421. As one embodiment, the module 300 may extract, transform, and load (ETL) data from external data source at step 1422 and access shared remote data at step 1423. At step 1430, the site and tower owner asset portfolio management module 310 defines new and edit existing site and tower owner asset portfolio at step 1431. As one embodiment, the module may defines new and edit existing site and tower profiles at step 1432 for a defined asset portfolio, analyzes the site and tower profiles of the asset portfolio at step 1433, and then generates and presents the analyzing result for the asset portfolio at step 1434. At step 1440, the co-location tenant project management module 320 defines new and edits existing tenant project 322 at step 1441. As one embodiment, the module 320 searches, selects, and links site and tower profiles to a defined tenant project 322 at step 1442. At step 1450, the design criteria and analysis option configuration definition module 360 defines design criteria and analysis option configurations. At step 1460, the site and tower information modeling and management module 350 defines new and edits existing configurations of information categories at step 1461, and selects configurations for information categories to define a site and tower information model at step 1465. The data for configurations may be provided by ordered external services and information sources 356 at step 1463. As one embodiment, the module 350 may generate 2D and/or 3D visualizations 370 of a defined site and tower information model at step 1466 and facilitate model review and editing at the 2D and/or 3D visualization interface at step 1467. As another embodiment, defining the general information and details for loading configuration at step 1464 takes multiple steps—add mounting structures, define independent load case (LC) for each mounting structure, specify loading details for each LC, and select LC for each mounting structure to create global loading case (GLC) for a site and tower information model. As another embodiment, at step 1462, the configurations data may be imported from external data sources 358 such as softwares and tools other than the network-based system 100. At step 1470, the engineering task management module 340 defines engineering tasks at step 1471. As one embodiment, the engineering task management module 340 selects one design criteria and analysis option configuration at step 1472 and one site and tower information model at step 1473 to define engineering tasks. Then, the engineering task management module 340 executes and delivers engineering tasks at step 1474.

In some embodiments, the terms “a” and “an” and “the” and similar references used in the context of describing a particular embodiment of the invention (especially in the context of certain of the following claims) can be construed to cover both the singular and the plural. The recitation of ranges of values herein is merely intended to serve as a shorthand method of referring individually to each separate value falling within the range. Unless otherwise indicated herein, each individual value is incorporated into the specification as if it were individually recited herein. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

While foregoing description includes many details and specifications, it should be understood that these have been included for purposes of explanation only, and are not to be interpreted as limitations of the present invention. Various changes and modifications to the presently preferred embodiments described herein will be apparent to those skilled in the art. Such changes and modifications can be made without departing from the spirit and scope of the present invention and without diminishing its intended advantage, as intended to be encompassed by the following claims and their legal equivalents.

What is claimed is:

1. A network-based system for site and tower information modeling and management, comprising:
a system database management module;
a system user management module;
a site and tower owner asset portfolio management module;
a co-location tenant project management module;
a design criteria and analysis option configuration definition module;
a site and tower information modeling module;
an engineering task management module;
said system database management module being configured for managing system databases;
said managing system databases comprising adding new data and editing existing data in the system databases, and said system databases comprising system general data and system specific data;
said system user management module being configured for registering a user account with new user account information, managing user account information of a registered user account, and assigning access privileges to said registered user account for accessing the network-based system;
said site and tower owner asset portfolio management module being configured for managing asset portfolios and managing site and tower profiles;
said site and tower profiles being a group of site and tower profiles for one asset portfolio;
said managing asset portfolios comprising creating new asset portfolios and editing
existing asset portfolios;
said managing site and tower profiles comprising creating new site and tower profiles and editing existing site and tower profiles;
said co-location tenant project management module being configured for managing tenant projects, searching and selecting site and tower profiles from said asset portfolios, linking selected site and tower profiles to said tenant projects, and monitoring progresses of said tenant projects;
said managing tenant projects comprising creating new tenant projects and editing existing tenant projects;
said design criteria and analysis option configuration definition module being configured for defining settings, making selections and assumptions for engineering modeling and engineering analysis;
said site and tower information modeling module being configured for managing site and tower information; and
said engineering task management module being configured for defining a new engineering task, executing said new engineering task, editing an existing engineering task, executing said existing engineering task, and delivering results for an executed engineering task.

2. The network-based system of claim 1, said system user management module comprising:
programs to register said user account at a network-connected interface, verify and activate the user account after submitting said user account's registration application with user account information;
programs to assign access privileges to said registered user account to access specified parts of the network-based system according to the user account information of said registered user account; and
programs to direct to the specified parts of the network-based system after login according to the assigned access privileges.

3. The network-based system of claim 2, said specified parts of the network-based system comprising parts or all of a collection of the system database management module, the site and tower owner asset portfolio management module, the tenant project management module, the design criteria and analysis option configuration definition module, the site and tower information modeling module, and the engineering task management module.

4. The network-based system of claim 1, said site and tower owner asset portfolio management module comprising programs to generate outputs to present and edit asset portfolio information and site and tower profile information, said outputs being in forms of table, plot, chart, and other Rich Internet Application (RIA) elements.

5. The network-based system of claim 4, wherein said asset portfolio information is information of one asset portfolio, said asset portfolio information comprising:
asset portfolio general information and asset portfolio statistical information;
said asset portfolio general information comprising asset portfolio name, asset portfolio attributes, number of site and tower profiles under the asset portfolio; and
said asset portfolio statistical information comprising statistical information of a group of site and tower profiles under the asset portfolio according to said site and tower profile information.

6. The network-based system of claim 1, said co-location tenant project management module comprising:
programs to search site and tower profiles in one or multiple site and tower owner asset portfolios using searching criteria;
said searching criteria comprising site and tower geographic information, structural capacity, number of tenant, tenant's name, and site and tower profile information;
programs to select the site and tower profiles returned from the search and link them to the tenant projects; and
programs to generate outputs to present and edit tenant project information, said outputs being in forms of table, plot, chart, and other Rich Internet Application (RIA) elements.

7. The network-based system of claim 6, said tenant project information comprising:
tenant project general information and tenant project statistical information;
said tenant project general information comprising tenant name, creation date, market region, description, number of site and tower profiles, and project progress; and
said tenant project statistical information comprising statistical information of a group of site and tower profiles of a tenant project according to site and tower profile information.

8. The network-based system of claim 1, said site and tower information modeling module comprising:
programs to create new configurations and edit existing configurations of information categories, select none or one configuration for each information category to define a site and tower information model;
programs to import and parse data from external data sources and fill information for said existing configurations and said new configurations for said information categories;
programs to order services for said new configurations and said existing configurations for the information categories;
programs to receive manually entered data for said new configurations and existing configurations for the information categories;
programs to receive inputs from service providers, save said inputs to the network-based system, link said inputs to the new configurations and the existing configurations for the information categories;
programs to generate 2D and 3D visualizations of objects defined in the site and tower information model;
programs to select visualized objects, review and modify the selected visualized objects in said 2D and 3D visualizations defined in said site and tower information model;
said configurations of information categories being multiple sets of data defining physical and functional characteristics of all objects for each information category; and
said external data sources comprising external site and tower information data files.

9. The network-based system of claim 1, said new engineering task and existing engineering task comprising:
loading analysis, structural analysis, foundation analysis, structural modification design and analysis, and construction support; and
said defining a new engineering task comprising selecting one design criteria and analysis option configuration and one site and tower information model.

10. The network-based system of claim 1, said engineering task management module comprising:
programs to read a defined engineering task to generate input files, create analysis model, calculate loads and apply the loads to the analysis model, perform analysis, perform analysis result checking; and
programs to deliver engineering task analysis results by generating deliverables, circulating the deliverables for check and verification, and submitting and presenting the deliverables, said deliverables comprising reports, calculations, and drawings.

11. A network-based method for site and tower information modeling and management, comprising:
defining data categorization and data structure, and designing system databases accordingly; managing system general data and system specific data of system databases;
managing a site and tower owner asset portfolio, wherein the site and tower owner asset portfolio comprises a plurality of site and tower profiles, and managing site and tower profiles of said site and tower owner asset portfolio;
managing a co-location tenant project, wherein said managing a co-location tenant project comprises performing statistic analysis of the data of said co-location tenant project and presenting the data;
managing a design criteria and analysis option configuration, said managing a design criteria and analysis option configuration comprising defining various design and analysis parameters based upon industrial standards and engineering practice;
managing a site and tower information model, wherein said managing a site and tower information model comprises defining information model information categories, allocating objects of a site and tower to said information categories, defining the objects, meshing the objects, creating vertices of the objects, defining connectivity of the vertices, creating visualization of the objects, construct engineering analysis functions, and associating the engineering analysis functions to the objects; and
managing an engineering task, wherein said managing an engineering task comprising executing the existing engineering task and the new engineering task, and generating deliverables for the executed existing engineering task and the executed new engineering task; said step of executing the existing engineering task and the new engineering task comprising transforming general physical data of objects of a site and tower to math data matrices, vectors for engineering analysis, performing engineering calculations and computations with numerical analysis methods; said step of generating deliverables for the executed existing engineering task and the executed new engineering task comprising extracting numerical results of said engineering calculations and computations, performing industrial design code checking, presenting the numerical results by generating plots, drawings and tables, generating technical calculations and reports.

12. The network-based method of claim 11, said step of managing system general data and system specific data of system databases comprising:
loading system general data to the system databases;
editing existing system general data in the system databases;
sharing remote system general data with the network-based system by providing an access to the remote system general data;
loading system specific data to the network-based system; and
said system specific data being saved at the network-based system or data storages managed by co-location tenants, site and tower owners, or their representatives.

13. The network-based method of claim 11, said step of managing site and tower owner asset portfolio and managing site and tower profiles of said site and tower owner asset portfolio comprising:
entering new asset portfolio information to define a new asset portfolio or editing asset portfolio information of an existing asset portfolio;
managing site and tower profiles of an asset portfolio, said asset portfolio being the new asset portfolio or the existing asset portfolio;
analyzing a group of site and tower profiles of said asset portfolio;
generating and presenting results from analyzing the group of site and tower profiles of said asset portfolio;
said managing site and tower profiles comprising adding a new site and tower profile to said asset portfolio or removing an existing site and tower profile from the existing asset portfolio; and
said managing site and tower profiles further comprising entering new site and tower profile data to define a new site and tower profile and editing site and tower profile data of an existing site and tower profile.

14. The network-based method of claim 11, said step of managing co-location tenant project further comprising:
entering new tenant project information to define a new co-location tenant project or editing tenant project information of an existing co-location tenant project;
searching and selecting site and tower profiles from one or multiple asset portfolios;
linking the selected site and tower profiles to the new co-location tenant project or the existing co-location tenant project; and
selecting and removing site and tower profiles from said existing co-location tenant project.

15. The network-based method of claim 11, said step of managing design criteria and analysis option configuration further comprising:
entering new data to define a new design criteria and analysis option configuration or editing existing data to edit an existing design criteria and analysis option configuration; and
said design criteria and analysis option configuration being a set of data specifying design criteria and analysis options.

16. The network-based method of claim 11, said step of managing site and tower information model further comprising:
defining new configurations of information categories;
said step of defining new configurations of information categories comprising a step of defining new loading configuration;
editing existing configurations of information categories;
said step of editing existing configurations of information categories comprising a step of defining new loading configuration and editing existing loading configuration;
Importing general information and details for existing configurations of information categories and new configurations of information categories from external data sources;
ordering services from service providers for the new configurations of information categories and existing configurations of information categories;
uploading files and entering data for the ordered services to the network-based system;
selecting none or one configuration for each information category;
generating 2D and 3D visualizations of objects defined in the configurations for a site and tower information model;
reviewing and editing the general information and details of the objects defined in the configurations for a site and tower information model through an interface of the generated 2D and 3D visualizations.

17. The network-based method of claim 16, said step of receiving and uploading files and entering data for the ordered services comprising:
uploading files for the ordered services to the network-based system; entering data through specified data-entering interfaces for external services; saving the entered data to the network-based system for the ordered services; and creating links between the uploaded files to the entered data in the network-based system.

18. The network-based method of claim 16, said step of defining new loading configuration and editing existing loading configuration comprising:
adding new mounting structures to the new loading configuration or existing loading configuration or editing existing mounting structures of the existing loading configuration;
creating new independent loading case for the new mounting structures or creating new and editing existing independent loading case for the existing mounting structures;
specifying new loading details for the new independent loading case or editing existing loading details for the existing independent loading case; and
selecting one or none new or existing independent loading case (LC) for each mounting structure to create a global loading case (GLC) for the site and tower information model.

19. The network-based method of claim 18, said new loading details and existing loading details comprising:
attaching relationships between objects of the site and tower information model;
information of global coordinate system and local coordinate systems of objects of the site and tower information model, relative translational offsets and rotational angles between the global coordinate system and the local coordinate systems, and relative translational offsets and rotational angles between the local coordinate systems;
identification information and position information of the mounting structure, discrete appurtenances attached to the mounting structure, and linear appurtenances connecting to the discrete appurtenances;
information of attaching members on the mounting structure for the discrete appurtenances; and
information of attaching members on structure for the linear appurtenances.

20. The network-based method of claim 11, said step of managing engineering task further comprising:
editing an existing engineering task by selecting one new design criteria and analysis option configuration for said existing engineering task, selecting one new site and tower information model for said existing engineering task, or linking said existing engineering task to a new tenant project;
creating a new engineering task for a site and tower profile and linking the new engineering task to a tenant project;
selecting one design criteria and analysis option configuration and one site and tower information model for said new engineering task;
linking the selected design criteria and analysis option configuration and the selected site and tower information model to the new engineering task;
circulating the deliverables for check and verification; and
submitting and presenting the deliverables.
